(19) United States
(12) Patent Application Publication
(10) Pub. No.: US 2013/0257811 A1
(43) Pub. Date: Oct. 3, 2013

(54) INTERACTIVE DISPLAY DEVICE

(71) Applicants: Yutaka Usuda, Tokyo (JP); Takahiro Miura, Tokyo (JP); Masahiko Kawana, Tokyo (JP); Shigeru Kano, Tokyo (JP)

(72) Inventors: Yutaka Usuda, Tokyo (JP); Takahiro Miura, Tokyo (JP); Masahiko Kawana, Tokyo (JP); Shigeru Kano, Tokyo (JP)

(73) Assignee: HITACHI SOLUTIONS, LTD., Tokyo (JP)

(21) Appl. No.: 13/642,601

(22) PCT Filed: Aug. 29, 2012
(86) PCT No.: PCT/JP2012/005443

§ 371 Date: Oct. 22, 2012

(30) Foreign Application Priority Data
Mar. 29, 2012 (JP) 2012-077675

(51) Int. Cl. G06F 3/042

(52) U.S. Cl. 345/175

(57) ABSTRACT

A projector 22 projects video onto a surface of an infrared light reflection member 26 following control by a PC 20. A detection unit 24 includes an infrared light emitter 28 and a depth camera 30. Since the infrared light which is reflected by the infrared light reflection member 26 does not return to the depth camera 30, the infrared light reflection member 26 is an area whose distance is unmeasurable. Further, a distance can be obtained outside the infrared light reflection member 26 since the infrared light is diffusely reflected. This allows obtainment of the relative relationship between the position of an outer periphery of the infrared light reflection member 26 and the position of an object 32. Accordingly, a touched position can be calculated, and a process on the basis of that is possible.

### TECHNICAL FIELD

The present invention relates to a device which enables interactive control by touching by a finger of a person, or the like, on a screen onto which an image is projected by a projector, or the like.

### BACKGROUND ART

Computers have been known that have a touch panel where an object on a screen can be operated by a finger, or the like. Since such computers facilitate intuitive operation, use of those has been rapidly increasing. However, realizing such a device with a large screen would require large cost for the touch panel and would result in difficulty in handling.

Accordingly, a touch screen device has been developed such that a projector and a camera are used in combination, a position of a pen or a finger on a screen onto which the projector projects an image is detected, and a computer is thereby operated.

FIG. 1 shows a touch screen device disclosed in JP-A-2011-253286. A projector 14 is connected to a PC 2. The projector 14 projects an image onto a detection area 4 following control by the PC 2 and displays the image.

A detection unit 6 is provided in an upper portion of the detection area 4. The detection unit 6 has a first detector 8 and a second detector 10. The first detector 8 includes an infrared light emitter 8a and infrared light detector 8b. Further, an infrared light reflector 12 is provided at left, right, and lower ends of the detection area 4. The infrared light detector 8b detects infrared light reflected by the infrared reflector 12. Similarly, the second detector 10 includes an infrared light emitter 10a and infrared light detector 10b.

Here, when a detection object such as a pen is present in the detection area, the infrared light detectors 8b and 10b detectsdetect it. Since the infrared light reflector 12 is configured such that it reflects the infrared light in the direction of its incidence, the infrared light detectors 8b and 10b can identify the angle with respects to the detection object. Accordingly, the PC 2 combines detection outputs of the infrared light detectors 8b and 10b and thereby identifies the position of the detection object.

The PC 2 controls the projector 14 in response to the detected motion of the detection object, for example, to perform drawing in the corresponding positions on the detection area 4. This causes the projector 14 to perform drawing.

As described above, interactive display control is enabled without using a special pen or the like.

FIG. 2 shows a touch screen device disclosed in JP-A-2011-126225. The projector 14 projects an image onto the detection area 4 following control by the PC 2 and displays the image.

The detection unit 6 is provided in an upper portion of the detection area 4. The detection unit 6 has the first detector 8b and the second detector 10b. A user moves an electronic pen 16 in the detection area 4. An infrared light emitter 18 is provided at a tip of the electronic pen 16. Accordingly, the infrared light detectors 8b and 10b can detect the angle with respect to the electronic pen 16. The PC 2 receives outputs from the infrared light detectors 8b and 10b and thereby identifies the position of the electronic pen 16.

The PC 2 controls the projector 14 in response to the detected motion of the electronic pen 16, for example, to perform drawing in the corresponding positions on the detection area 4. This causes the projector 14 to perform drawing.

### SUMMARY OF INVENTION

### Technical Problem

However, the device in accordance with Patent Document 1 requires the infrared light reflector 12. Accordingly, there is a problem in that the device tends to become large in size so that the touch screen device is configures to have the built-in infrared light reflector 12. Further, if the device is configured such that the infrared light reflector 12 has to be arranged for use each timeuse, the infrared light reflector 12 has to be carried. Handling of the device is troublesome.

Further, the device in accordance with Patent Document 2 requires a special apparatus such as the electronic pen 16. Therefore, when the electronic pen 16 is lost, it cannot be easily replaced.

An object of the present invention is to provide a touch screen device which solves problems such as described above and enables interactive control without requiring a special apparatus such as a bulky infrared light reflector or an electronic pen.

### Solution to Problem

Followings are some aspects of the present invention.

(1)(2)(3) An interactive display device in accordance with the present invention includes: a detection area member to be disposed in an detection area and having a detection light reflection surface which reflects detection light; a detection light emitting section disposed for emitting the detection light toward the detection area; a depth sensor which is provided in a position on which the detection light reflected by the detection light reflection surface is not incident, receives the detection light reflected by a detection object positioned in the detection area and the detection light reflected by a portion surrounding the detection light reflection surface, and obtains respective distance to the detection object and the portion surrounding the detection light reflection surface: a position calculation means for calculating a position of the detection object in the detection area according to output of the depth sensor; a video display section for displaying video on the detection light reflection surface; and a video control means for changing video displayed on the detection light reflection surface by the video display section in response to the position of the detection object calculated by the position calculation means.

This enables interactive control without requiring a special apparatus such as an infrared light reflector or an electronic pen.

(4) In the interactive display device in accordance with the present invention, the position calculation means determines that the detection object touches the detection light reflection surface according to a detected distance according to the detection light reflected by the detection object and further by the detection light reflection surface in addition to a detected distance according to the detection light reflected by the detection object.

Accordingly, a process can be performed on the basis of the touch of the detection object onto the detection light reflection surface.

(5) The interactive display device in accordance with the present invention further includes: an infrared image capturing section disposed for capturing an infrared image in the detection area; and a range image production means for producing a range image according to the detected distance, in which the position calculation means determines that the detection object touches the detection light reflection surface according to an offset in images of the detection object between the infrared image and the range image.

Accordingly, the process can be performed on the basis of the touch of the detection object onto the detection light reflection surface.

(6) In the interactive display device in accordance with the present invention, the detection light is infrared light.

This allows the detection light for the interactive control to be invisible.

(7) A touched position detection method in accordance with the present invention includes: disposing in a detection area a detection area member having a detection light reflection surface which reflects detection light; disposing a detection light emitting section for emitting the detection light toward the detection area; calculating respective distances to a detection object and a portion surrounding the detection light reflection surface while receiving the detection light reflected by the detection object positioned in the detection area and the detection light reflected by the portion surrounding the detection light reflection surface in a position on which the detection light reflected by the detection light reflection surface is not incident; and calculating a position of the detection object in the detection area according to the calculated distance.

This enables interactive control without requiring a special apparatus such as an infrared light reflector or an electronic pen.

(8)(9)(10) An interactive display device in accordance with the present invention includes: a detection area member to be disposed in an detection area and having a detection light absorption surface which absorbs detection light; a detection light emitting section disposed for emitting the detection light toward the detection area; a depth sensor which receives the detection light reflected by a detection object positioned in the detection area and the detection light reflected by a potion surrounding the detection light absorption surface and obtains respective distances to the detection object and the portion surrounding the detection light reflection surface; a position calculation means for calculating a position of the detection object in the detection area according to output of the depth sensor; a video display section for displaying video on the detection light absorption surface; and a video control means for changing video displayed on the detection light absorption surface by the video display section in response to the position of the detection object calculated by the position calculation means.

This enables interactive control without requiring a special apparatus such as an infrared light reflector or an electronic pen.

(11) The interactive display device in accordance with the present invention includes: an infrared image capturing section disposed for capturing an infrared image in the detection area; and a range image production means for producing a range image according to the detected distance, in which the position calculation means determines that the detection object touches the detection light absorption surface according to an offset in images of the detection object between the infrared image and the range image.

Accordingly, the process can be performed on the basis of the touch of the detection object onto the detection light absorption surface.

(12) In the interactive display device in accordance with the present invention, the video display section is a projector.

Accordingly, display is performed by the projector.

(13) In the interactive display device in accordance with the present invention, the video display section is a display, and the detection area member is disposed on a surface of the display.

Accordingly, a touch panel can be realized without using transparent electrodes or the like.

In embodiments, the “position calculation means” corresponds to step S5 of FIG. 6 or step S5 of FIG. 15.

In the embodiments, the “video control means” corresponds to step S6 of FIG. 6 or step S6 of FIG. 15.

The “program” is a concept that includes not only a program which can be directly implemented by a CPU but also a source program, a compressed program, an encrypted program, or the like.

### BRIEF DESCRIPTION OF DRAWINGS

FIG. 1 illustrates a conventional interactive display device.

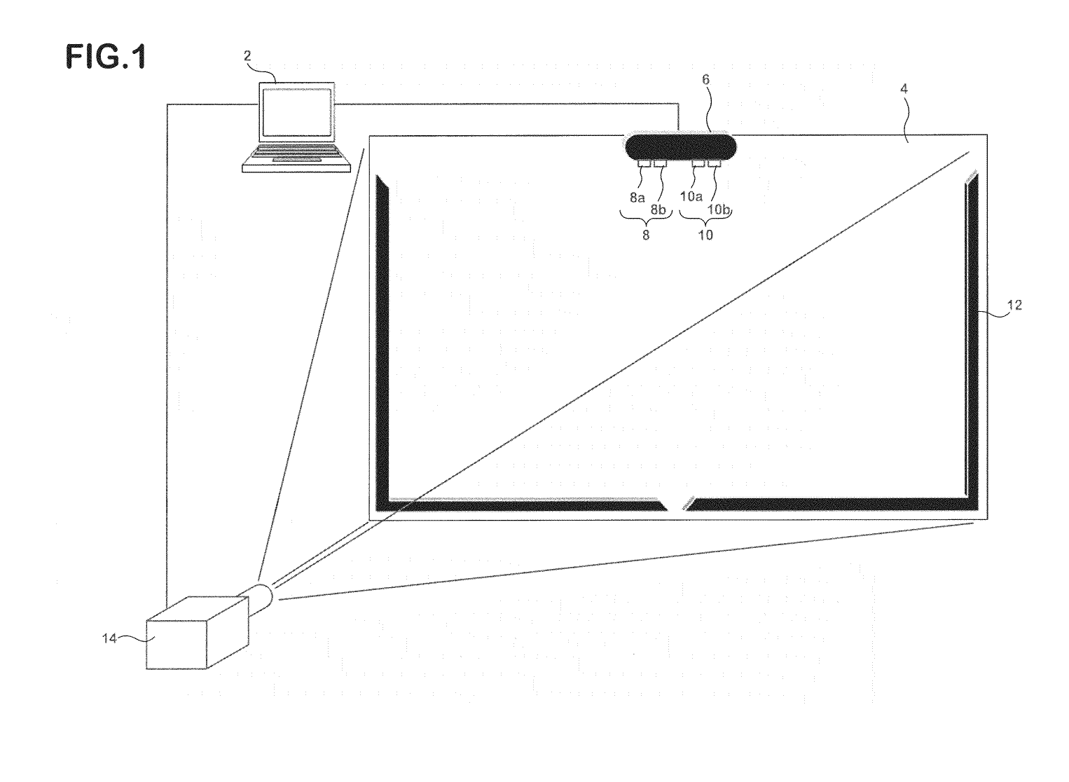

FIG. 2 illustrates a conventional interactive display device.

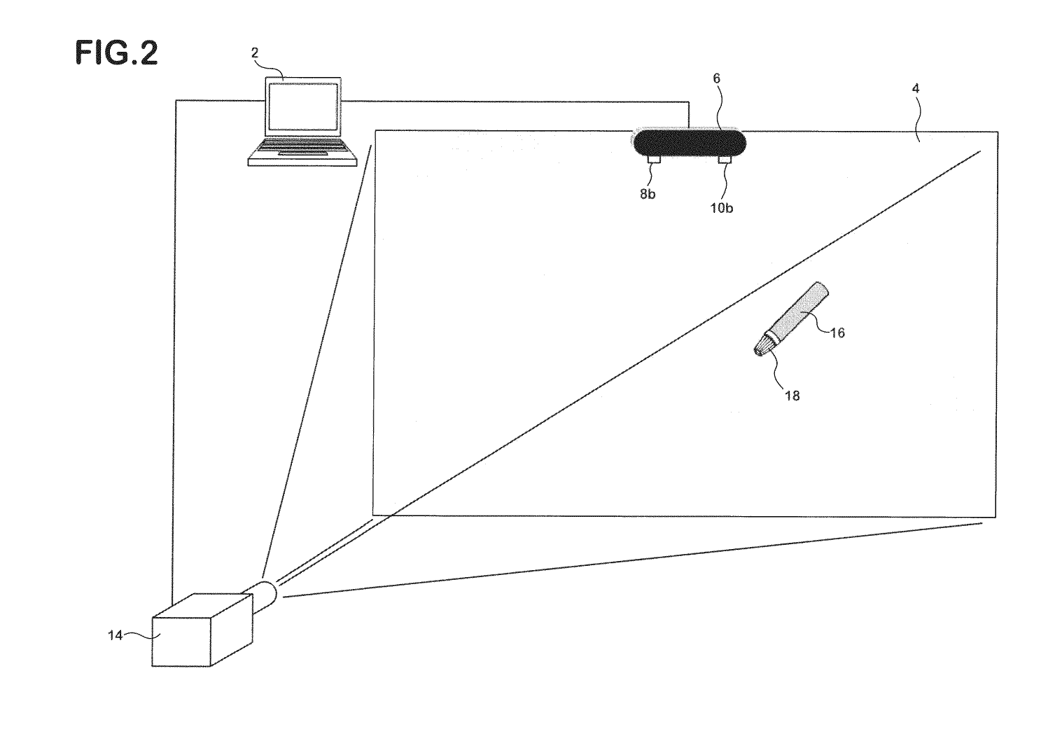

FIG. 3 illustrates an appearance of an interactive display device in accordance with an embodiment of the present invention.

FIG. 4 illustrates a principle of the interactive display device in accordance with the embodiment.

FIG. 5 illustrates a hardware configuration of the interactive display device.

FIG. 6 is a flowchart of a control program 56.

FIG. 7 illustrates an example of a range image in a case that no finger is present in a detection area.

FIG. 8 illustrates an example of the range image in a case that a finger is present in a detection area.

FIG. 9 illustrates an example of the range image in a case that the finger touches an infrared light reflection member 26.

FIG. 10 illustrates a principle by which a reflection image is produced.

FIGS. 11A-B area examples of a range image of the finger.

FIGS. 12A-B illustrate a method of position identification by coordinate transformation.

FIGS. 13A-B illustrate an example where the infrared light reflection member 26 is disposed in a grid shape (linear shapes).

FIG. 14 is a flowchart of the control program 56 in accordance with a second embodiment.

FIG. 15 is a flowchart of the control program 56 in accordance with a second embodiment.

FIGS. 16A-B illustrate examples of a range image with no finger present and with the finger present.

FIGS. 17A-B illustrates an example of a differential image in the range image and an extracted outline.

FIG. 18 illustrates the outline in an infrared image.

FIGS. 19A-B are views for comparing the outline in the range image with the outline in the infrared image.

FIG. 20 is a view for comparing a tip of the outline in the range image with a tip of the outline in the infrared image.

FIG. 21 illustrates an example of the infrared light reflection member 26 in accordance with another embodiment.

### DESCRIPTION OF EMBODIMENTS

### 1. First Embodiment

### 1.1. General Construction

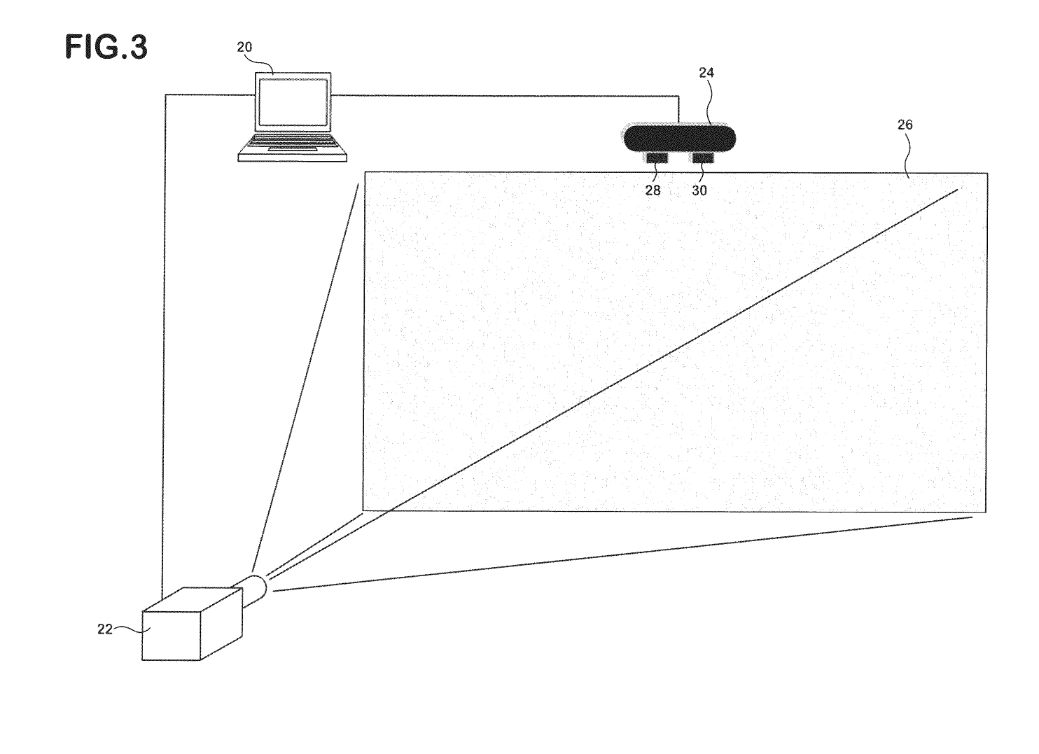

FIG. 3 shows an appearance of a touch screen device in accordance with an embodiment of the present invention. A projector 22 and a detection unit 24 isare connected to a PC 20. An infrared light reflection member 26 as a detection area member is provided in a detection area. A surface of the infrared light reflection member 26 is an infrared light reflection surface which reflects infrared light.

It is required that the infrared light reflection member 26 reflect infrared light emitted by a depth camera 30 (reflect the infrared light to the extent that the distance is unmeasurable). For example, a laminated polyester film (3M Scotchtint Glass Film Multilayer Nano 80S (trademark™)) which reflects infrared light can be used.

The projector 22 projects video onto the surface of the infrared light reflection member 26 following control by the PC 20.

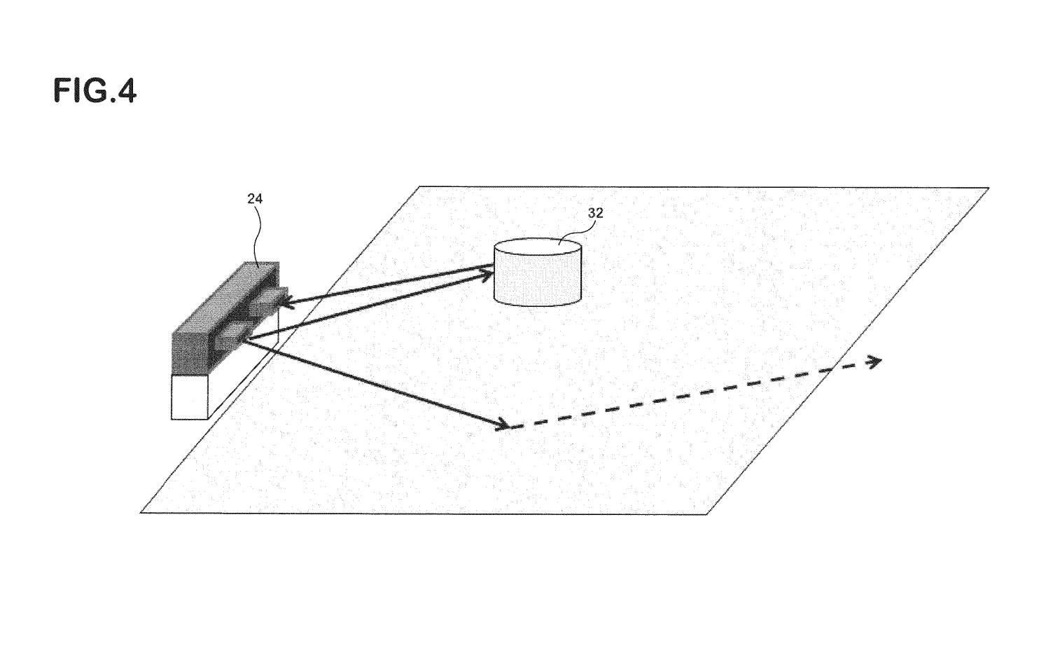

The detection unit 24 includes an infrared light emitter 28 and the depth camera 30. The depth camera 30 outputs the distances to the areas corresponding to respective pixels. As shown in FIG. 4, the detection unit 24 can receive the infrared light, which is emitted from the infrared light emitter 28 and is reflected by a detection object 32, and can thereby obtain the distance to the detection object 32. Since the infrared light which is reflected by the infrared light reflection member 26 does not return to the depth camera 30, the infrared light reflection member 26 is an area whose distance is unmeasurable. Further, a distance can be obtained outside the infrared light reflection member 26 since the infrared light is diffusely reflected.

As shown in FIG. 4, the detection unit 24 is configured such that the infrared light emitter 28 and the depth camera 30 have heights of approximately 20 cm to 30 cm with respect to the infrared light reflection member 26.

### 1.2. Hardware Configuration

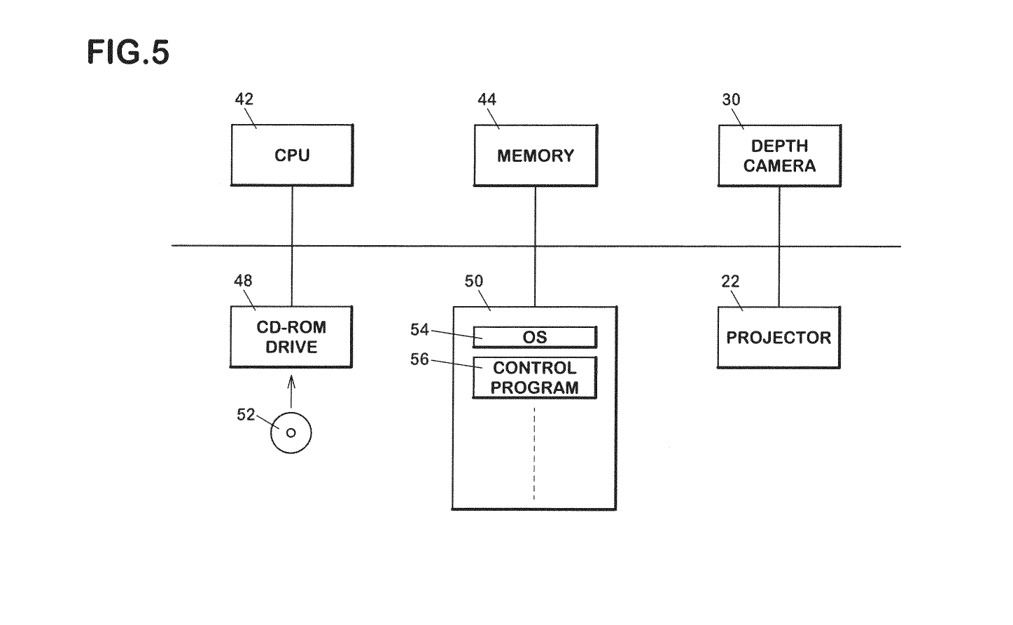

FIG. 5 shows a hardware configuration of the touch screen device. A memory 44, the depth camera 30, a CD-ROM drive 48, a hard disc 50, and the projector 22 are connected to a CPU 42.

The hard disc 50 stores an operating system (OS) 54 such as WINDOWS (trademark™) and a control program 56. The control program 56 cooperatively provides its function with the OS 54. The OS 54 and the control program 56 are originally stored in a CD-ROM 52, and those are installed in the hard disc 50 via the CD-ROM drive 48.

### 1.3. Process Flowchart

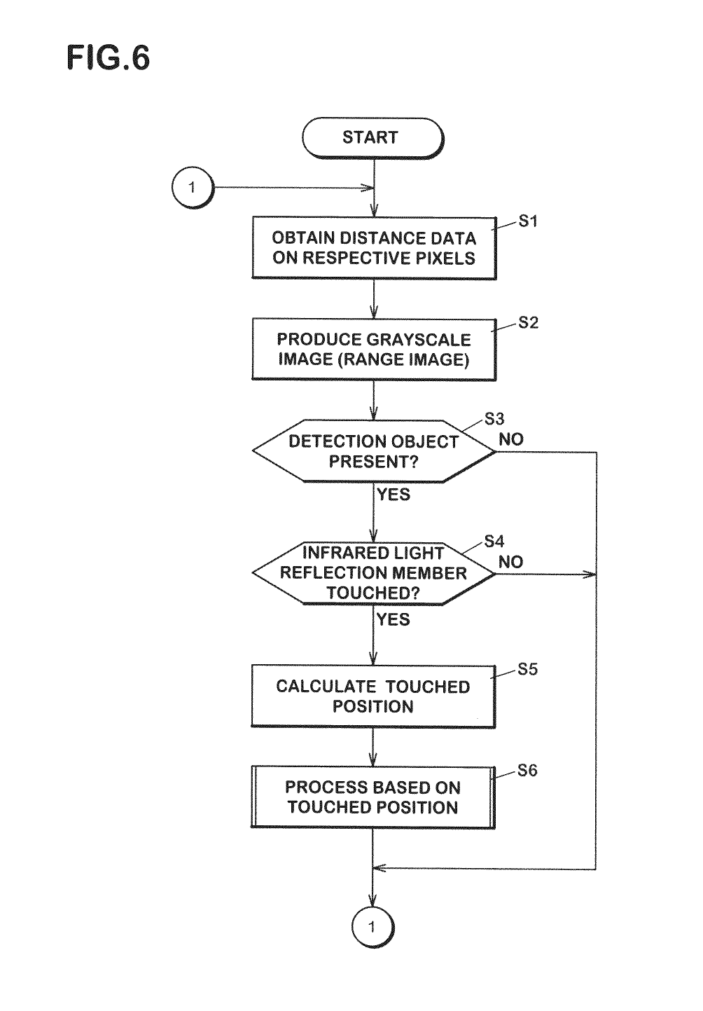

FIG. 6 is a flowchart of the control program 56. The CPU 42 obtains distance data of respective pixels from the depth camera 30 (step S1). In this embodiment, an image capturing range of the depth camera is slightly wider than the infrared light reflection member 26 as the detection area.

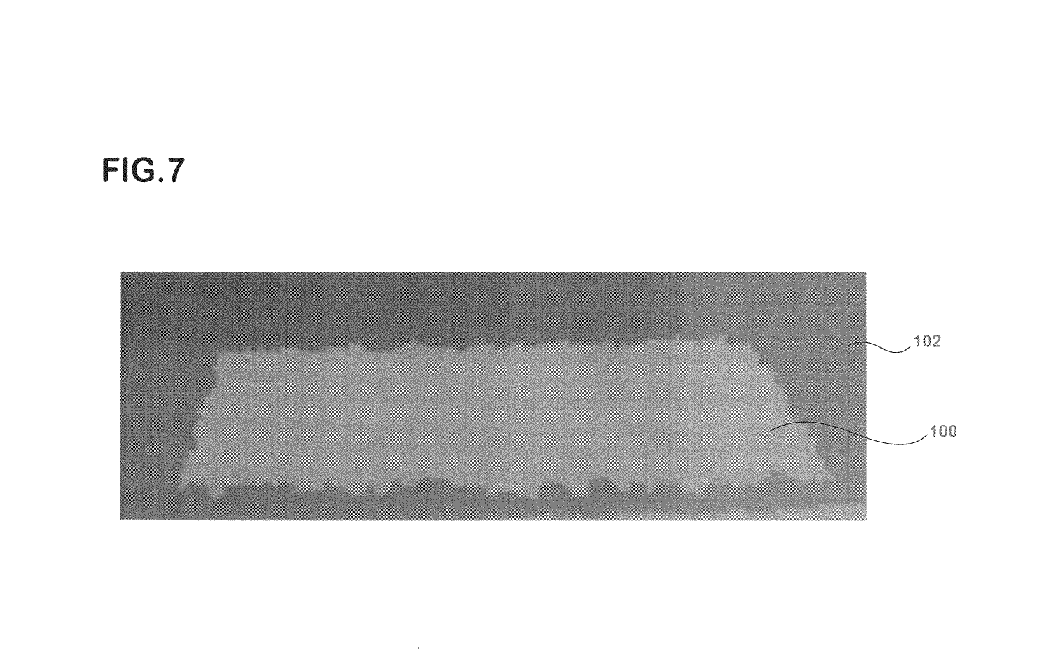

The CPU 42 produces a range image (grayscale image) in which pixels have different densities in response to distances on the basis of the obtained distance data on the respective pixels (step S2). FIG. 7 shows an example of the range image produced as described above. In this embodiment, the shorter the distance is, the denser the density becomes, and the longer the distance is, the less dense the density becomes.

The infrared light does not return from the infrared light reflection member 26. Therefore, this is assumed as an infinitely far distance (unmeasurable), thus appearing in a less dense color as shown by an area 100 in FIG. 7. Further, measurement can be performed in a portion surrounding the infrared light reflection member 26 since the infrared light is diffusely reflected. Accordingly, as shown by an area 102, such a portion is displayed in a denser color than the area 100.

As described above, the detection area (in other words, the area where the infrared light reflection member 26 is present) can be distinguished from the other area as images. That is, the CPU 42 identifies coordinates (positions of the pixels) of four corners of the detection area.

Next, the CPU 42 determines whether the detection object is present in the detection area (step S3). In this embodiment, since an object which reflects the infrared light can be detected, a finger of a person, a stick, or the like, can serve as the detection object. If the detection object is present in the detection area, the infrared light is reflected by the detection object, thereby allowing obtainment of the distance data to be obtained.

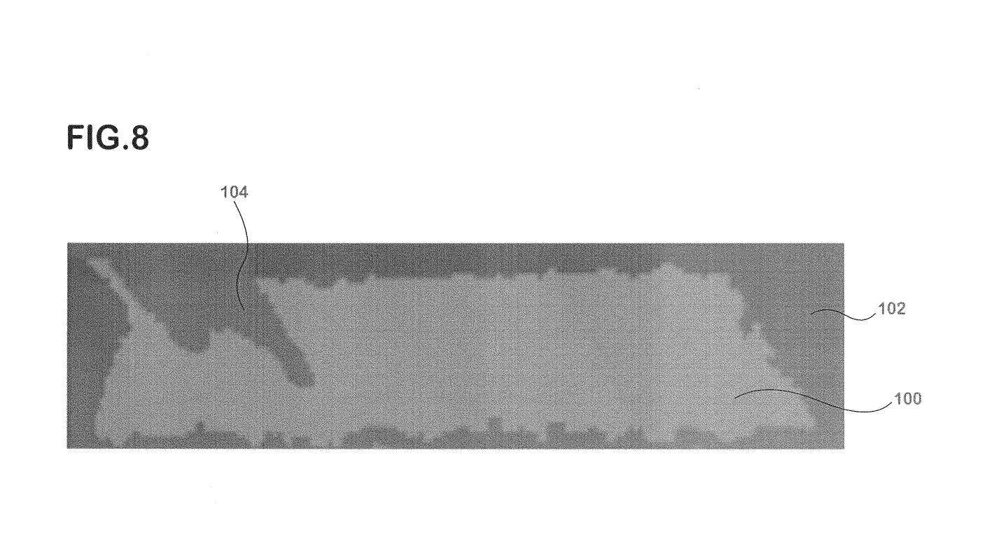

FIG. 8 shows the range image when the finger as the detection object is detected. An area 104 is a portion which represents the finger. The distance data area obtained in the area 104, and the area 104 is displayed in a denser color than the infrared light reflection member 26 as a background.

The CPU 42 extracts the pixels denser than a prescribed density (in other words, the pixels closer than a prescribed distance) in the detection area. For example, the pixels whose distance data area shorter than two meters area extracted. For example, the pixels whose distance data are shorter than two meters are extracted. Further, the CPU 42 calculates a pixel number of a cluster of the pixels which is denser than the prescribed density. The cluster having a pixel number smaller than the prescribed number (for example, the cluster having an area smaller than 20 pixels) is determined as not the detection object and is excluded. As described above, it is determined whether or not the detection object is present. If the CPU 42 determines that the detection object is not present, the CPU 42 returns to step S1 and again performs the process.

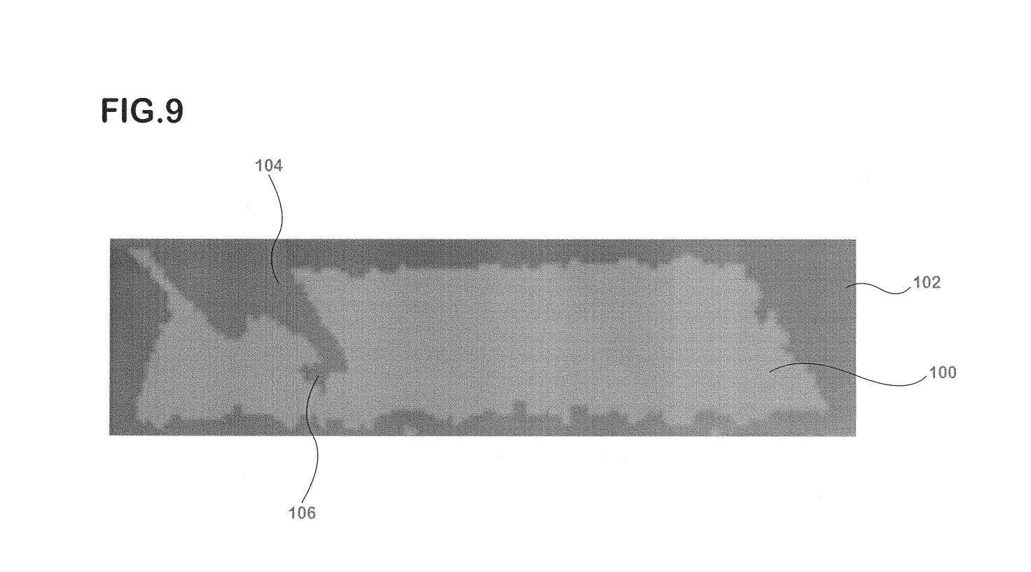

If it is determined that the detection object is present, the CPU 42 determines whether the detection object touches the infrared light reflection member 26 (step S4). FIG. 8 shows the range image where the finger as the detection object is not touching the infrared light reflection member 26. FIG. 9 shows the range image where the finger touches the infrared light reflection member 26.

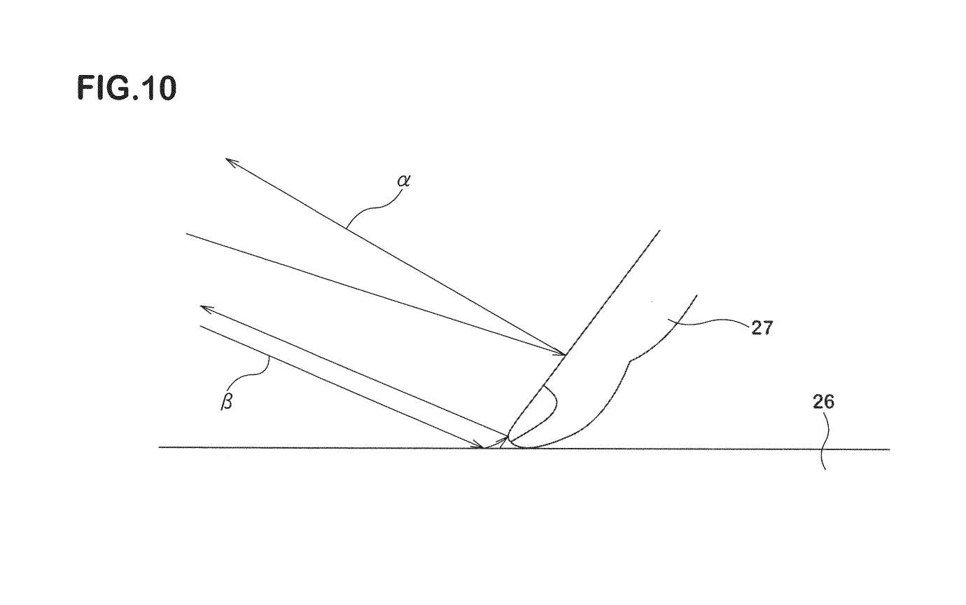

As shown in FIG. 9, when the finger touches the infrared light reflection member 26, a reflection image 106 appears. As shown in FIG. 10, this occurs because the infrared light reflected by the infrared light reflection member 26 and a finger 27 as shown by a locus b is detected besides the direct reflection by the finger 27 as shown by a locus a. The CPU 42 determines whether the finger 27 is touching the infrared light reflection member 26 according to whether or not such a reflection image is present.

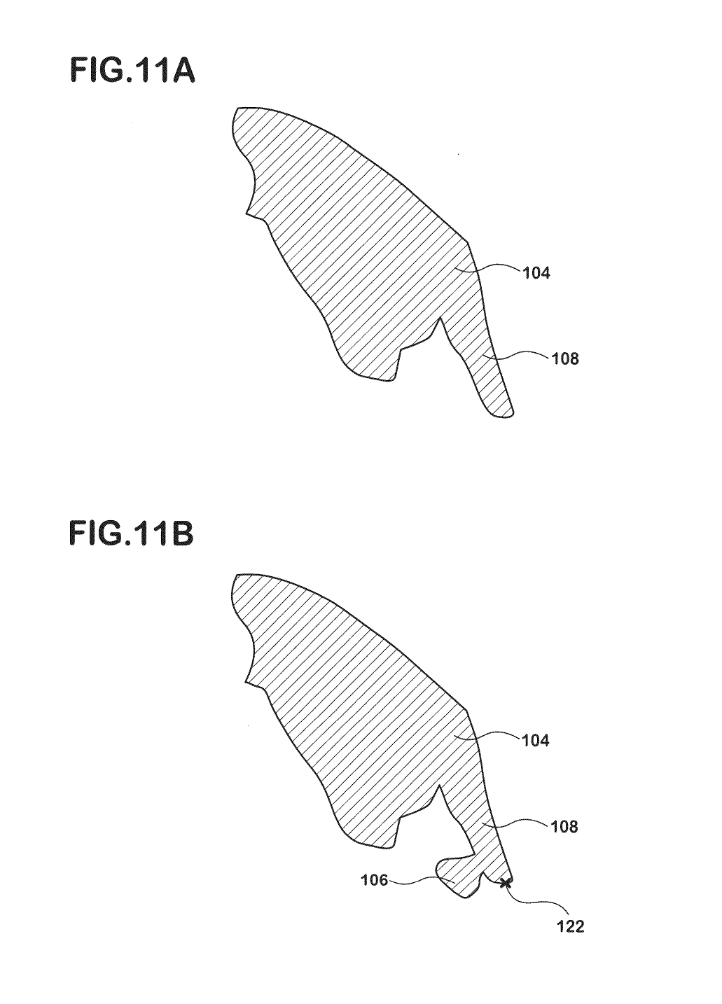

The detail of the determination by the CPU 42 is as follows. First, the contour of the detection object is extracted. The outline of the image of FIG. 8 is extracted as shown in FIG. 11A. The outline of the image of FIG. 9 is extracted as shown in FIG. 11B.

Thereafter, the CPU 42 finds an area 108 whose length is twice as long as or longer than its width in the detection object. Next, the CPU 42 determines whether a protrusion (a portion which is connected to the area 108 in a narrow width and has a wider width than the joint of the connection) which is integral with the area 108. If the protrusion is present, the protrusion is recognized as the reflection image 106. The CPU 42 calculates the area of the reflection image 106. If the area is a prescribed value or larger, the CPU 42 determines that the detection object has touched the infrared light reflection member 26.

Accordingly, since the reflection image 106 is not observed in FIG. 8 (FIG. 11A), the CPU 42 determines that the finger as the detection object has not touched the infrared light reflection member 26. Further, since the reflection image 106 is observed in FIG. 9 (FIG. 11B), the CPU 42 determines that the finger as the detection object is touching the infrared light reflection member 26.

When the CPU 42 detects the touch by the detection object, the CPU 42 calculates the touched position (step S5). In this embodiment, the touched position is calculated as follows.

First, the coordinates on the image of the four corners of the infrared light reflection member 26 (in other words, the detection area) are obtained on the basis of the range image (see FIG. 7) where no detection object is present. This process is preferably performed as preprocessing for use.

In FIG. 11B, the coordinate on the range image of a tip 122 of the finger is obtained. Next, on the basis of the vertical and horizontal dimensions of the infrared light reflection member 26 that are preliminary recorded, the coordinates on the image and the positions on the infrared light reflection member 26 are correlated, and the coordinate of the tip 122 is transformed into the position on the infrared light reflection member 26.

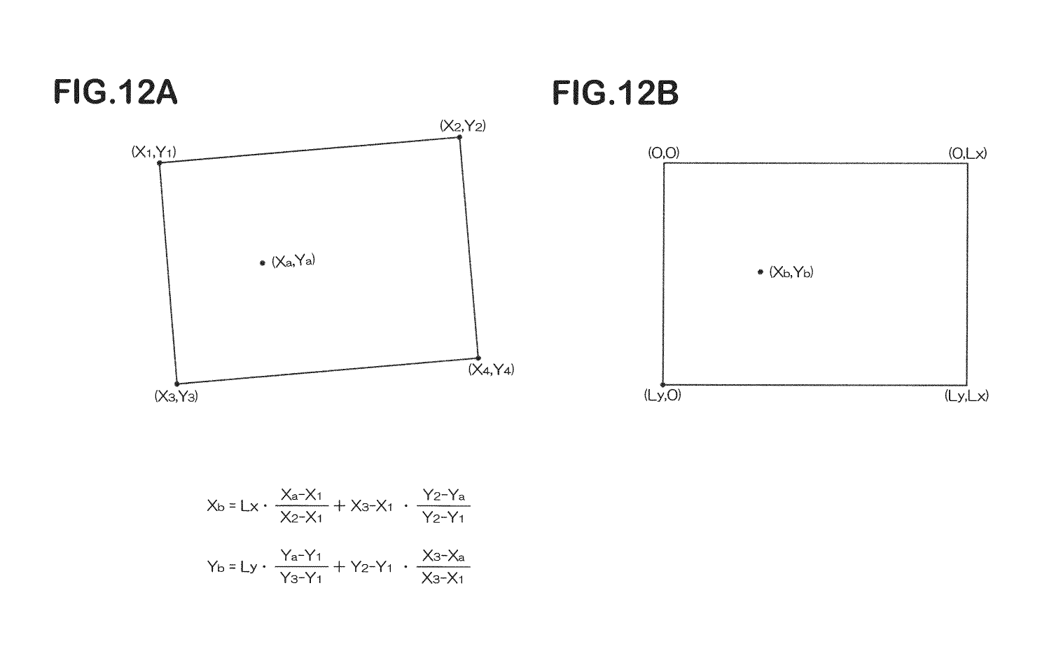

For example, as shown in FIG. 12A, it is given that the coordinates on the image of the four corners of the infrared light reflection member 26 are (X1, Y1), (X2, Y2), (X3, Y3), and (X4, Y4) and the touched position on the image is (Xa, Ya). Those coordinates are transformed into a coordinate (Xb, Yb) (a coordinate system where the upper left end is (0,0) and the lower right end id (Lx, Ly)) on the infrared light reflection member 26. In such a case, transformation equations shown in a lower portion of FIG. 12 can be used. The touched position is calculated as described above.

Next, the CPU 42 performs a process corresponding to an operation mode (step S6). For example, in a drawing mode, drawing is performed in response to the motion of the detection object. The CPU 42 repeats such processes.

As described above, in this embodiment, the position of the detection object is detected and a process corresponding to that can be performed without using a special pen, a reflection member, or the like.

### 1.4. Other Embodiments

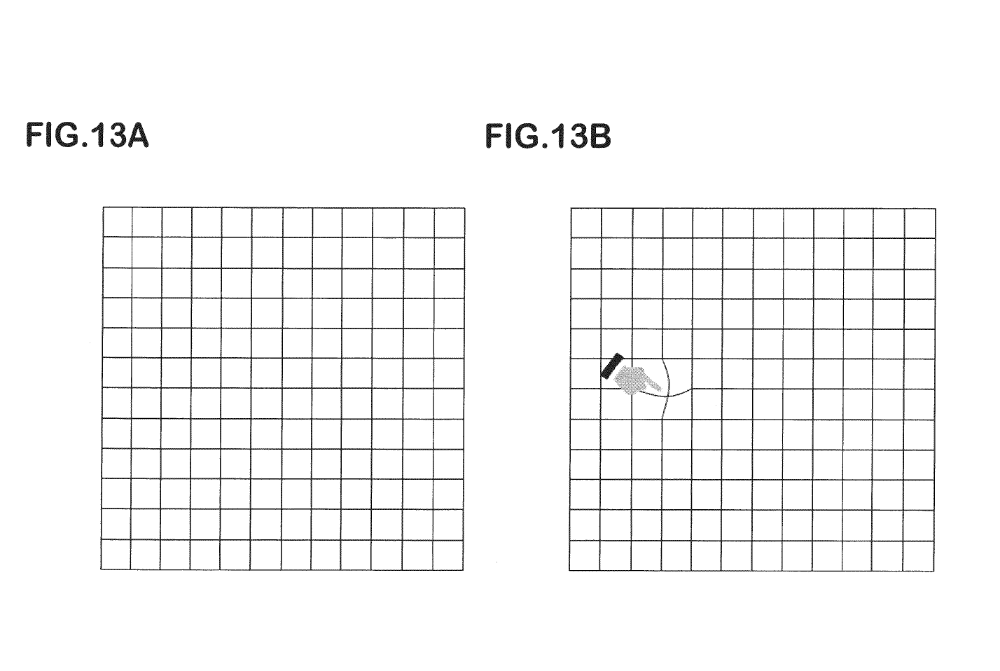

(1). In the embodiment described above, the infrared light reflection member 26 is provided throughout the detection area. However, as shown in FIG. 13A, the infrared light reflection member 26 may be provided in a grid shape. As shown in FIG. 13B, when the grid is touched by the detection object, the grid is distorted in the range image. Such a distorted position may be detected as the touched position.

(2). In the embodiment described above, the depth camera 30 is used as a depth sensor. Typically, the depth camera 30 may be capable of outputting infrared images. However, in this embodiment, since infrared images are not used, a sensor can be used that outputs no infrared image but depth.

### 2. Second Embodiment

### 2.1. General Configuration and Hardware Configuration

A general configuration and a hardware configuration are the same as the first embodiment. However, this embodiment is different from the first embodiment in the use of infrared images of the depth camera.

### 2.2. Process Flowcharts

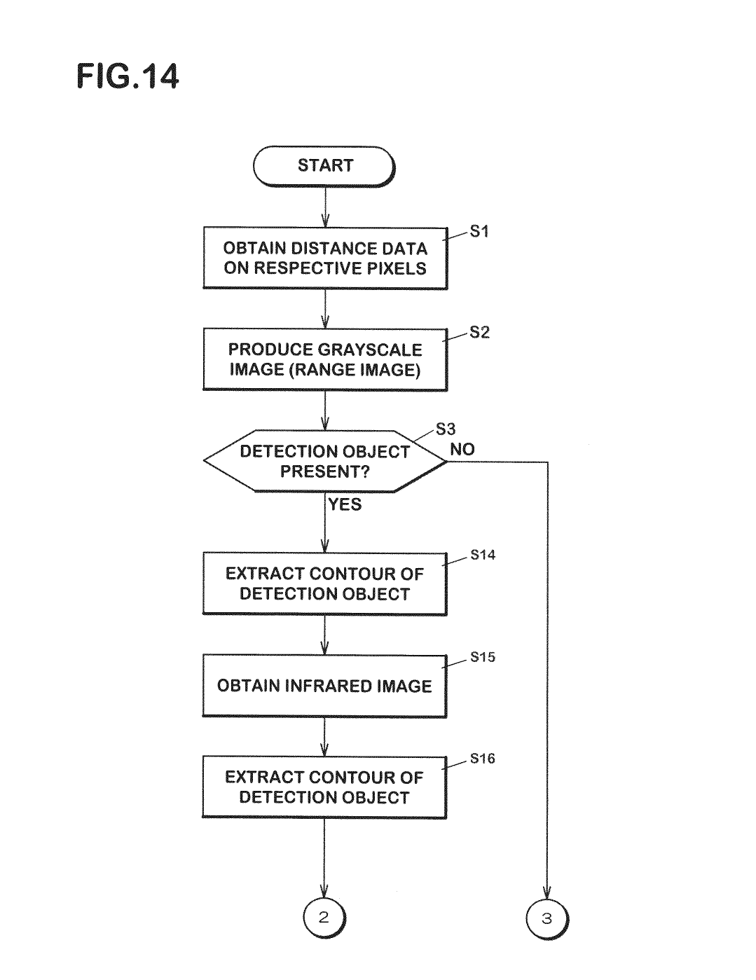

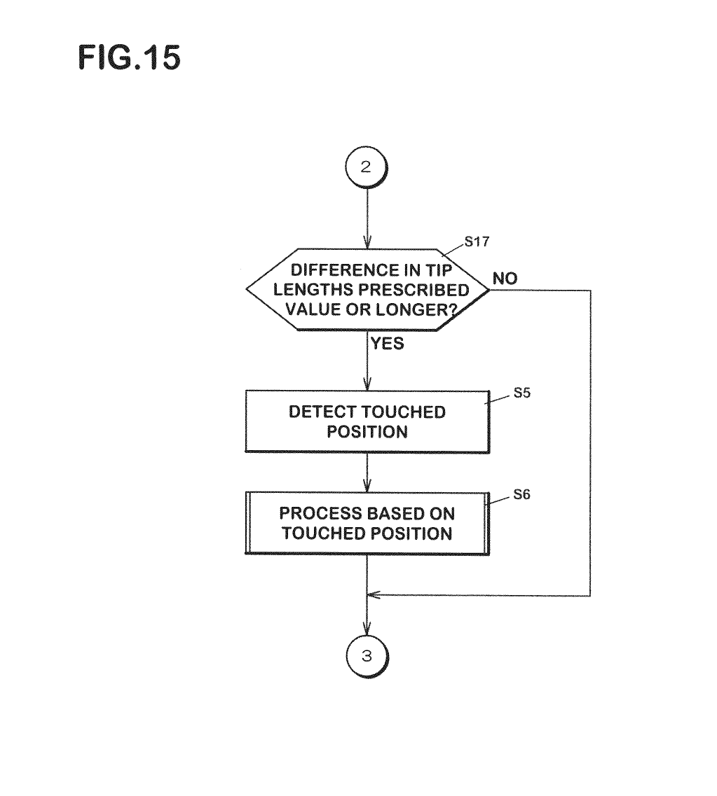

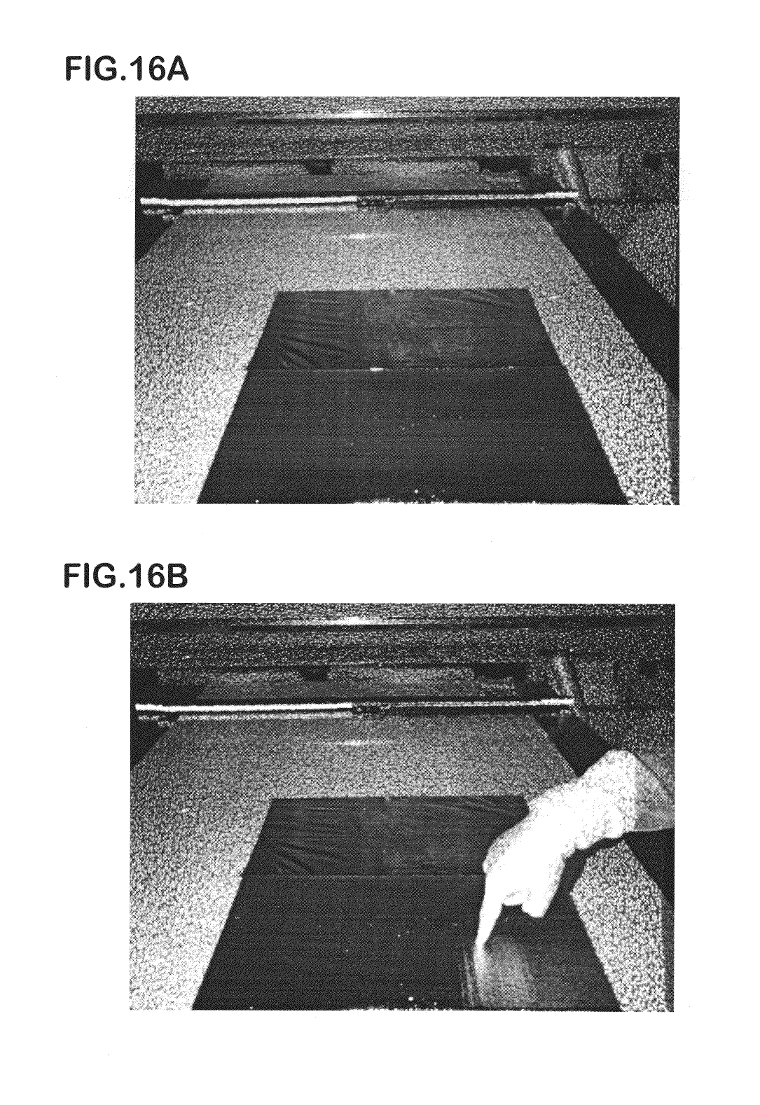

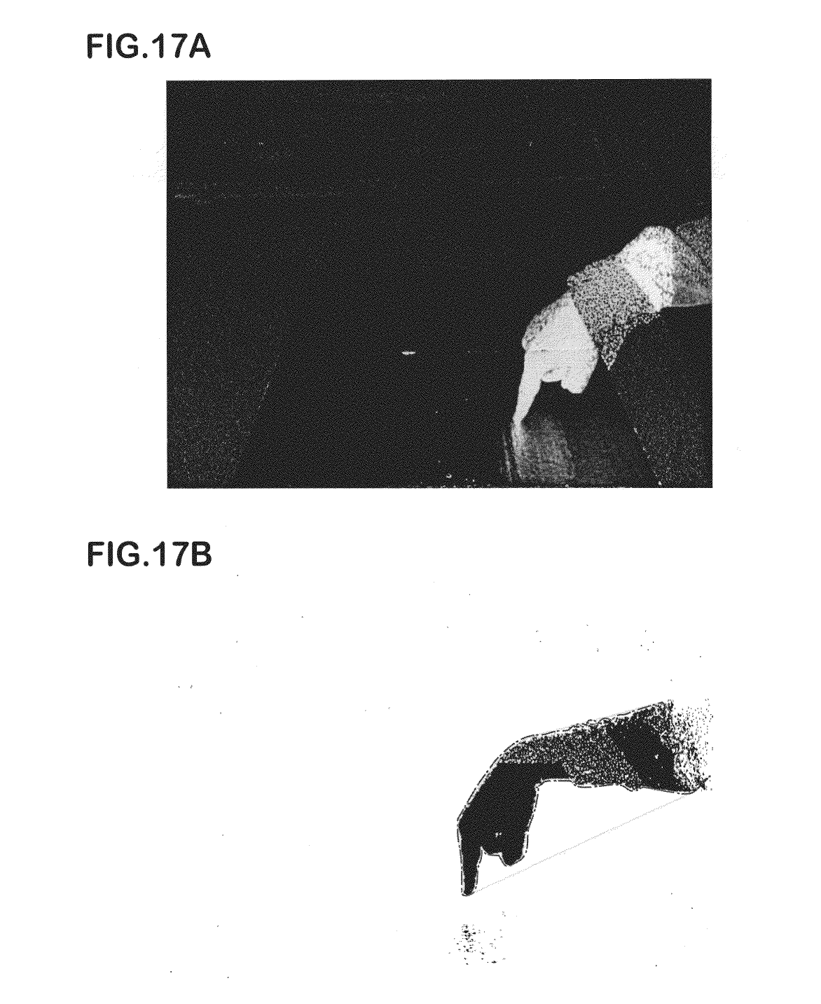

FIGS. 14 and 15 show process flowcharts of the control program 56. Steps S1 to S3 are the same as those as shown in FIG. 6. In this embodiment, the range image where no detection object is present is preliminary stored as a reference range image, and a determination is made whether or not the detection object is present on the basis of a differential image between the range image during measurement and the reference range image. FIG. 16A shows the reference range image, and FIG. 16B shows the range image during measurement. FIG. 17A shows the differential image between those. When the differential image having a cluster larger than a prescribed area is present, it is determined that the detection object is present.

If it is determined that the detection object is present, the CPU 42 extracts the contour of the detection object in the range image (step S14). FIG. 17B shows the extracted contour.

Next, the CPU 42 obtains the infrared image from the depth camera 30 (step S15). Thereafter, the CPU 42 extracts the contour of the detection object in the infrared image on the basis of the contour of the detection object in the range image (step S16). In this embodiment, the same range is captured in the range image and the infrared image, which have the same number of pixels. Accordingly, referring the contour of the detection object in the range image facilitates the extraction of the contour of the detection object in the infrared image.

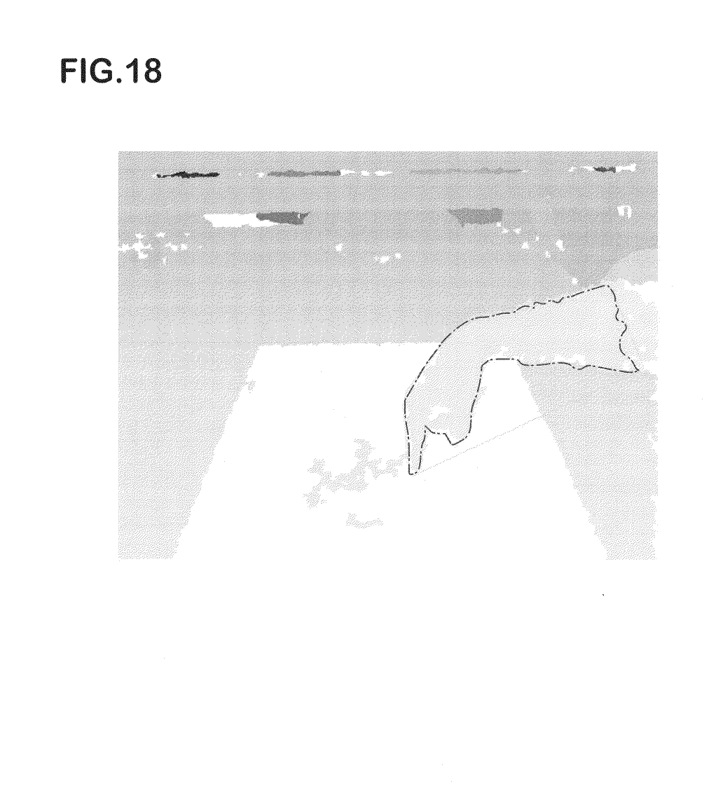

FIG. 18 shows the contour of the detection object in the infrared image, which is extracted in such a manner. It is obvious from the comparison between the contours in FIGS. 17B and 18 that both of them almost correspond with each other. When the detection object does not touch the infrared light reflection member 26, the contours of both of them correspond with each other as described above. Accordingly, the CPU 42 determines that the detection object does not touch the infrared light reflection member 26 if the difference in the length between the tips of the detection objects in the contours in the range image and the infrared image is smaller than a prescribed value (step S17).

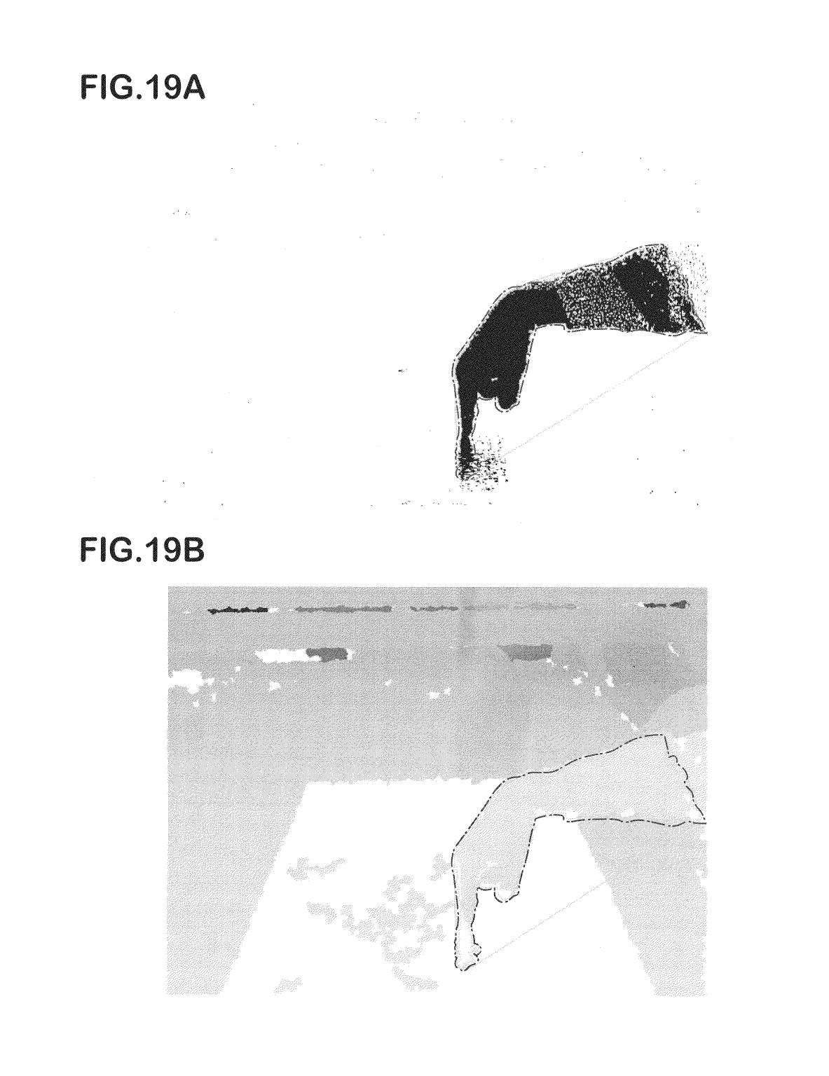

On the other hand, as shown by the range image of FIG. 19A and by the infrared image of FIG. 19B, if the detection object is touching the infrared light reflection member 26, the respective tip lengths of the contours of the detection objects are different. This occurs because when the detection object touches (extremely closely approaches) the infrared reflection member 26, a shadow (silhouette) of the detection object is also detected as an image. In such a case, the silhouette is more vivid and large in the infrared image but is smaller in the range image. Because of such features, when the detection object touches the infrared light reflection member 26, the tips of the contours differ in length.

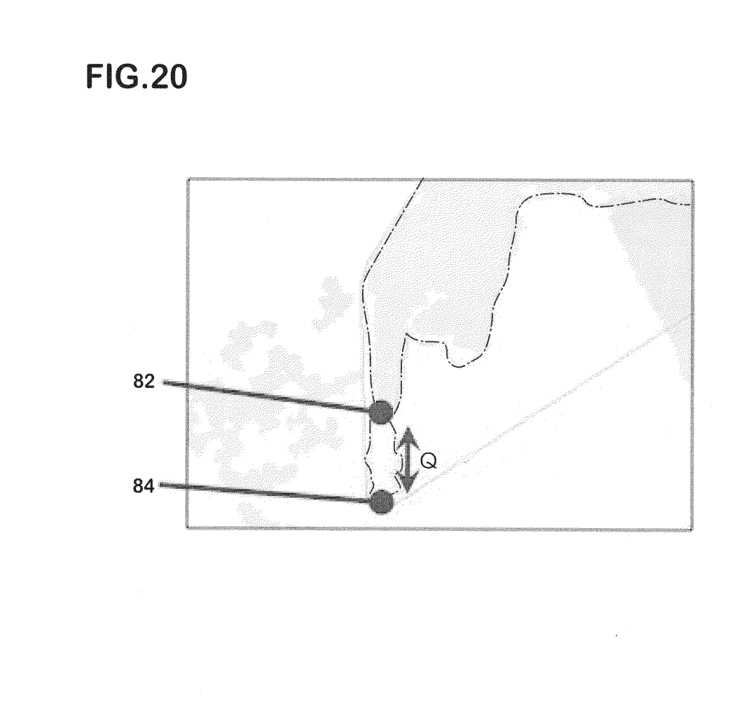

Accordingly, as shown in FIG. 20, the CPU 42 determines that the detection object has touched the infrared light reflection member 26 if a difference Q between a lowermost end (tip) 82 of the contour in the range image and a lowermost end (tip) 84 of the contour in the infrared image exceeds a prescribed length (approximately five to ten cm in the actual length measurement) (step S17).

Thereafter, the CPU 42 calculates the touchpad position (step S5). This process is performed by calculating the coordinate of the lowermost end 82 of the contour in the range image. The calculation method is the same as the first embodiment.

After the calculation of the touched position, similarly to the first embodiment, the CPU 42 performs a process on the basis of the touched position (step S6).

2.3. Other Embodiments

(1). In each of the embodiments described above, the infrared light reflection member 26 is provided in the detection area. However, an infrared light absorption member may be used instead.

(2). In each of the embodiments described above, the detection unit 24 is disposed in a different position from the projector 14. However, the projector 14 is provided with the depth camera 24. Alternatively, the detection unit 24 is unitarily formed with the projector 14.

(3). In each of the embodiments described above, infrared light and the infrared light reflection member 26 are used. However, instead of that, ultrasound waves and an ultrasound wave reflection member (absorption member), ultraviolet light and an ultraviolet light reflection member (absorption member), electromagnetic waves and an electromagnetic wave reflection member (absorption member), or the like may be used.

(4). In each of the embodiments described above, the projector is used as a video display section. However, a display may be used. In such a case, a touch panel can be realized without using transparent electrodes or the like.

(5). In each of the embodiments described above, an example having the finger as the detection object is described. However, objects that reflect infrared light such as normal writing tools and pointers may be used as the detection object.

(6). The device in each of the embodiments described above may be constructed as a preliminary assembled device or may be constructed as a device by carrying the depth camera and the infrared light reflection member and arranging the infrared light reflection member 26 on a desk, a wall, or the like.

(7). In each of the embodiments described above, the CPU detects a touch by the detection object onto the infrared light reflection member 26 and thereby performs the process. However, the process may be performed regardless of whether or not a touch is made as long as the detection object is detected.

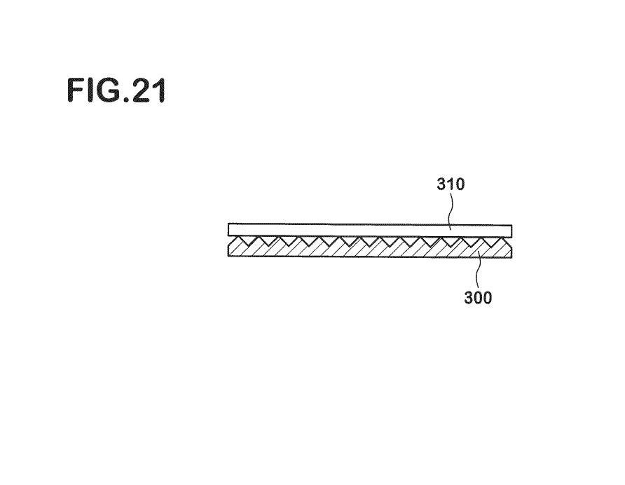

(8). In the embodiments described above, the infrared light reflection member which reflects infrared light in a normal manner is used. However as shown in FIG. 21, a member where an infrared light reflection section 300 having a structure which reflects infrared light in its incident direction is covered by a transparent film 310 which reflects infrared light to a certain extent may be used as the infrared light reflection member 26. Since the infrared light reflection section 300 reflects infrared light in its incident direction, the infrared light emitted from the infrared light emitter 28 returns to the infrared light emitter 28. Therefore, when no detection object is present, the infrared light is not detected by the depth camera 30 which is located in a position distant from the infrared light emitter 28, and the distance is unmeasurable. If the detection object is present, the infrared light reflected by that is detected, and distance measurement data can be obtained.

1. An interactive display device comprising:
a detection area member to be disposed in a detection area and having a detection light reflection surface which reflects detection light;
a detection light emitting section disposed for emitting the detection light toward the detection area;
a depth sensor which is provided in a position on which the detection light reflected by the detection light reflection surface is not incident, receives the detection light reflected by a detection object positioned in the detection area and the detection light reflected by a portion surrounding the detection light reflection surface, and obtains respective distances to the detection object and the portion surrounding the detection light reflection surface;
a position calculation means for calculating a position of the detection object in the detection area according to output of the depth sensor;
a video display section for displaying video on the detection light reflection surface; and
a video control means for changing video displayed on the detection light reflection surface by the video display section in response to the position of the detection object calculated by the position calculation means.

2. A touched position detection device comprising:
a detection area member to be disposed in a detection area and having a detection light reflection surface which reflects detection light;
a detection light emitting section disposed for emitting the detection light toward the detection area;
a depth sensor which is provided in a position on which the detection light reflected by the detection light reflection surface is not incident, receives the detection light reflected by a detection object positioned in the detection area and the detection light reflected by a portion surrounding the detection light reflection surface, and obtains respective distances to the detection object and the portion surrounding the detection light reflection surface; and
a position calculation means for calculating a position of the detection object in the detection area according to output of the depth sensor.

3. A non-transitory computer readable medium having a program capable causing a computer to perform as a touched position detection device including:
wherein the computer is caused to function as a position calculation means that is provided in a position on which detection light reflected by a detection light reflection surface is not incident when the detection light is emitted to a detection area in which the detection light reflection surface is disposed, receives the detection light reflected by a detection object positioned in the detection area and the detection light reflected by a portion surrounding the detection light reflection surface, and calculates a position of the detection object in the detection area according to respective distances to the detection object and the portion surrounding the detection light reflection surface.

4. The device according to claim 2,
wherein the position calculation means determines that the detection object touches the detection light reflection surface according to a detected distance according to the detection light reflected by the detection object and further by the detection light reflection surface in addition to a detected distance according to the detection light reflected by the detection object.

5. The device according to claim 2, further comprising:
an infrared image capturing section disposed for capturing an infrared image in the detection area; and
a range image production means for producing a range image according to the detected distance,
wherein the position calculation means determines that the detection object touches the detection light reflection surface according to an offset in images of the detection object between the infrared image and the range image.

6. The device according to claim 2,
wherein the detection light is infrared light.

7. A touched position detection method comprising:
disposing in a detection area a detection area member having a detection light reflection surface which reflects detection light;
disposing a detection light emitting section for emitting the detection light toward the detection area;
calculating respective distances to a detection object and a portion surrounding the detection light reflection surface while receiving the detection light reflected by the detection object positioned in the detection area and the detection light reflected by the portion surrounding the detection light reflection surface in a position on which the detection light reflected by the detection light reflection surface is not incident; and
calculating a position of the detection object in the detection area according to the calculated distance.

8. An interactive display device comprising:
a detection area member to be disposed in a detection area and having a detection light absorption surface which absorbs detection light;
a detection light emitting section disposed for emitting the detection light toward the detection area;
a depth sensor which receives the detection light reflected by a detection object positioned in the detection area and the detection light reflected by a portion surrounding the detection light absorption surface and obtains respective distances to the detection object and the portion surrounding the detection light reflection surface;
a position calculation means for calculating a position of the detection object in the detection area according to output of the depth sensor;
a video display section for displaying video on the detection light absorption surface; and
a video control means for changing video displayed on the detection light absorption surface by the video display section in response to the position of the detection object calculated by the position calculation means.

9. A touched position detection device comprising:
a detection area member to be disposed in a detection area and having a detection light absorption surface which absorbs detection light;
a detection light emitting section disposed for emitting the detection light toward the detection area;
a depth sensor which receives the detection light reflected by a detection object positioned in the detection area and the detection light reflected by a portion surrounding the detection light absorption surface and obtains respective distances to the detection object and the portion surrounding the detection light reflection surface;
a position calculation means for calculating a position of the detection object in the detection area according to output of the depth sensor.

10. A non-transitory computer readable medium having a program capable causing a computer to perform as a touched position detection device including:
wherein the computer is caused to function as a position calculation means calculates a position of a detection object in a detection area according to output from a depth sensor which receives detection light reflected by the detection object positioned in the detection area and the detection light reflected by a portion surrounding a detection light absorption surface when the detection light is emitted to the detection area in which the detection light absorption surface is disposed and obtains respective distances to the detection object and the portion surrounding the detection light absorption surface.

11. The device according to claim 9, further comprising:
an infrared image capturing section disposed for capturing an infrared image in the detection area; and
a range image production means for producing a range image according to the detected distance,
wherein the position calculation means determines that the detection object touches the detection light absorption surface according to an offset in images of the detection object between the infrared image and the range image.

12. The device according to claim 2, wherein the video display section is a projector.

13. The device according to claim 2, wherein the video display section is a display, and
the detection area member is disposed on a surface of the display.

14. The device according to claim 9, wherein the video display section is a projector.

15. The device according to claim 9, wherein the video display section is a display, and
the detection area member is disposed on a surface of the display.
